(19) United States
(12) Patent Application Publication
(10) Pub. No.: US 2013/0294098 A1
(43) Pub. Date: Nov. 7, 2013

(54) Adjustable Lamp Socket Extender

(71) Applicant: John Yeh, Chino Hills, CA (US)

(72) Inventor: John Yeh, Chino Hills, CA (US)

(21) Appl. No.: 13/539,509

(22) Filed: Jul. 2, 2012

Related U.S. Application Data
(60) Provisional application No. 61/643,867, filed on May 7, 2012.

(51) Int. Cl. F21V 21/22

(52) U.S. Cl. 362/429

(57) ABSTRACT

Disclosed herein is a lamp socket extender, generally comprising a base section, an extendable body, and a head section. The base section connects to a light socket, such as an Edison style light socket. The head section attaches to a lamp adapter, which holds a lamp. The extendable body is capable of extending to create more or less distance between the head section and the base section. In a preferred embodiment, the extendable body is comprised of a core covering and a telescopic covering. There may be a wiring harness utilized to more easily attach and detach the wiring from the lamp to the lamp socket extender.

This patent application claims the benefit of, priority of, and incorporates by reference U.S. Provisional Patent Application Ser. No. 61/643,867, entitled “Adjustable Lamp Socket Extender” by John Yeh filed on May 7, 2012.

### BACKGROUND OF THE INVENTION

1. Field of the Invention

The present invention relates generally to a socket extender, and more particularly, to a lamp socket extender.

2. Description of the Related Art

It is general knowledge that the common light socket allows a standard light bulb to be screwed into it. These standard light bulbs have at their base an Edison screw which is compatible with and can twist into the common light socket. The light socket and light bulb's Edison screw come in various sizes, with E26 being the most common in North America. Other sizes include E10, E11, E12, E14, E17, etc. The number after the “E” refers to the base diameter in millimeters.

The standard light bulb as most people know it today is an incandescent light bulb. CFLs (compact fluorescent lamps) have gained in popularity recently due to their energy savings and relatively low cost. Both the incandescent light bulb and CFL generally have an Edison screw base and can be screwed into a standard light socket (aka Edison screw-base socket).

Newer lighting technology such as LED and induction lighting are gaining popularity. Induction lighting has many advantages. An induction lamp is also known as electrodeless lamp. An induction lamp is a light source in which the power required to generate light is transferred from the outside of the lamp envelope by means of electromagnetic field. In contrast, a typical electrical lamp uses electrical connections through the lamp envelope to transfer power. Induction lamps have the advantage of a much higher life, and typically have a rated lamp life of 100,000 hours. HID lamps and T5HO typically have a rated lamp life around 20,000 hours. This means induction lamps can usually go 10 years without having to be changed out. The energy efficiency of induction lamp is typically about 140 lumens per watt. In contracts, the energy efficiency of a Metal Halide (HID) is about 110 lumens per watt and T5HO is about 90 lumens per watt. Induction lighting has an instant on capability (allowing for use with photocell and motion sensors), and does not flicker, strobe, or generate noise. The higher energy efficiency of an induction lamp typically results in lower operating temperatures. An induction lamp generally operates at less than 80 degrees F. Generally, a Metal Halide operates at over 300 degrees F., compact fluorescent operates at over 150 degrees F., and LED operates around 75-120 degrees F.

Light generated by different methods produce light of different qualities, and the human eye perceives this light differently. Scotopic vision is the human visual perception in low-light (night-vision), directed by the rod cells in human eyes. Photopic vision is the human color vision under normal conditions, during the day, directed by cone cells in the human eye. Mesopic vision is the combination between Photopic and Scotopic vision, taking into account the total sensitivity of the rod cells in the eye for blue range, with the color perception of the cone cells. Research has been conducted to better understand Mesopic vision, and more specifically, how Scotopic vision stimulates the photoreceptors, rods, in the human eye to cause pupil contraction and increase visual acuity. It was found that scotopically enhanced light appeared brighter even when light levels were reduced. The ratio of Scotopic light vs. Photopic light in a lamp is called P/S (or S/P) ratio. This ratio determines the apparent visual brightness of a light source. Induction lighting produces a high S/P ratio and this is why an 85 w induction lamp may appear as bright or brighter to the human eye than a sodium vapor or metal halide of twice the wattage. Visual Effective Lumens (VEL) is a key factor in vision and many traditional lumen meters will not measure this conversion factor accurately. The “pupil lumens” is encouraged to be used which factors in the P/S ratio. By using the pupil lumens of various lamp types, a more representative effective lumens perceived by the human eye can be measured. The general pupil lumen per watt for a Metal Halide is about 110, compact fluorescent is about 85, LED is about 75-120, and induction lamp is about 130-150.

As these newer lighting technologies, such as induction lighting, gain popularity and drop in price, there is a desire to use them due to their advantages over existing lighting technologies such as incandescent lamps and CFLs.

### BRIEF SUMMARY OF THE INVENTION

An adjustable lamp socket extender is disclosed which attaches to a lamp at the head, and attaches to a lamp socket as a power source at the base. In a preferred embodiment, the lamp is an induction lamp that is attached to a lamp adapter, and the lamp adapter attaches to the head of the adjustable lamp socket extender. Also in a preferred embodiment, the base of the adjustable lamp socket extender is an Edison style screw. The lamp socket extender has a base covering, and a telescopic covering. In a preferred embodiment, the telescopic covering slides over the base covering. Under the covering is a track and extension arm. The extension arm may extend out, to extend the range of the adjustable lamp socket extender, and the extension arm remains covered by the telescopic covering while extended.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a perspective view of a preferred embodiment of a lamp socket extender attached to a circular induction lamp.

FIG. 2 is a perspective view of a preferred embodiment of a lamp socket extender, with its extension arm partially slid out, and attached to a circular induction lamp.

FIG. 3 is side view of a preferred embodiment of a lamp socket extender, fully extended.

FIG. 4 is a side view of a preferred embodiment of a lamp socket extender, fully extended, with its telescopic covering pulled back.

FIG. 5 is a bottom perspective view of a preferred embodiment of a lamp socket extender, fully extended, with its telescopic covering removed.

FIG. 6 is a side view of a preferred embodiment of a lamp socket extender, partially extended, with its telescopic covering removed.

### DETAILED DESCRIPTION

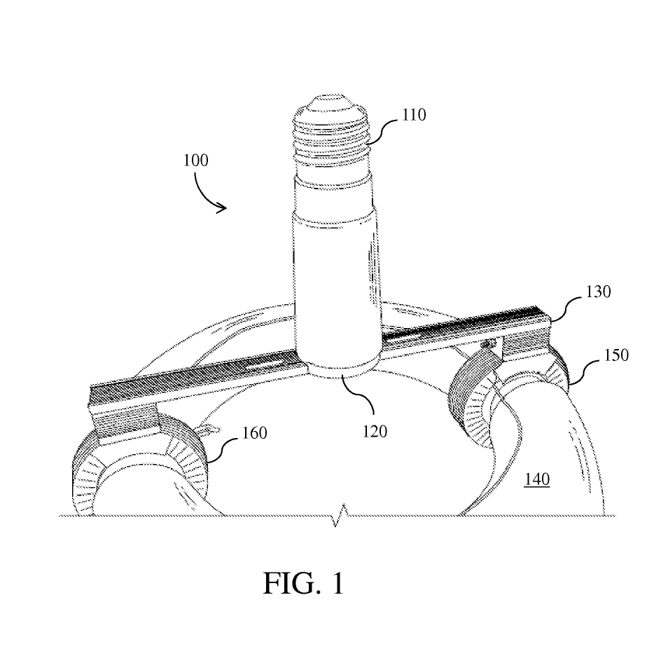

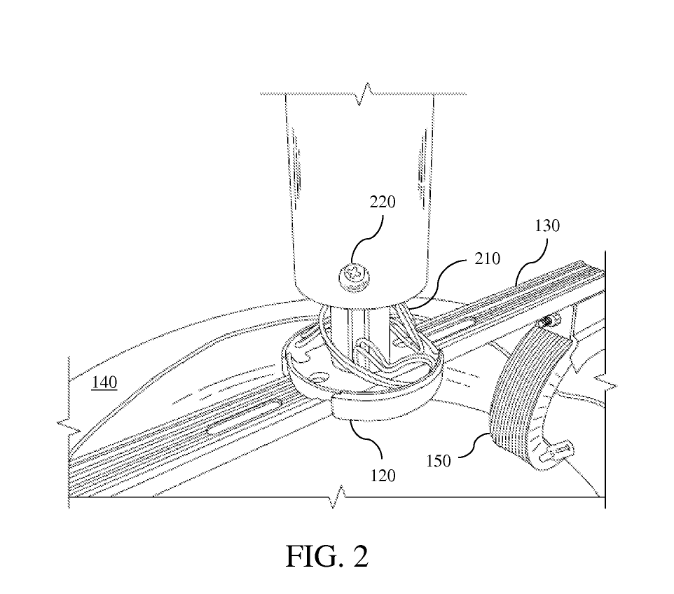

FIG. 1 shows a preferred embodiment of a lamp socket extender 100 in its contracted position, attached to an induction lamp. In this embodiment, the lamp socket extender 100 has an E26 Edison screw at its base 110. In other embodiments, other styles and shapes of lamp socket connectors may be utilized by the lamp socket extender other than an E26 Edison screw. Some other styles and shapes are other types of Edison screws, bayonet collar, single pin, multiple pin, glass wedge, flanged, and slide. The other end (head) 120 of the lamp socket extender is fixedly attached to a lamp adapter 130. The lamp adapter is fixedly attached to an induction lamp 140 at the two coils 150 160. In other embodiments, the lamp adapter may vary in shape and style, and be attached to other types of lamps, such as, but not limited to, fluorescent, incandescent, HID, LED, Halogen, and CFL. The extendable body is the section between the base 110 and head 120. There is wiring that carries the electrical current from the E26 lamp socket connector to the induction lamp adapter, and wiring to ultimately lead to the coils of the induction lamp to power the induction lamp. FIG. 2 shows the lamp socket extender with its telescopic cover removed to show some of this wiring 210 underneath the coverings.

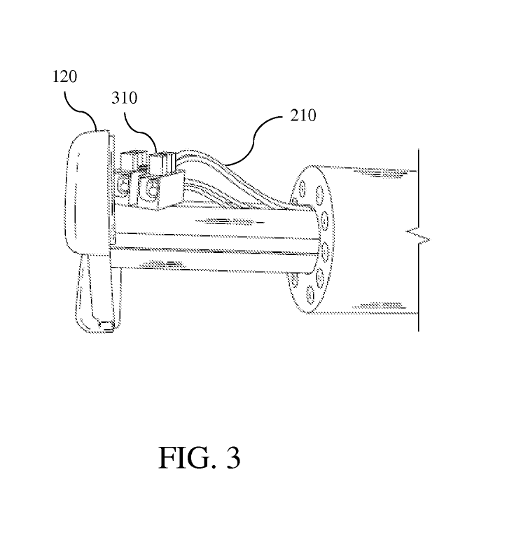

FIG. 3 shows the wiring 210 attached to a wire harness 310 in this preferred embodiment. As mentioned, the wiring 210 conducts the electricity from the Edison screw at the base to a wiring harness 310 near the head 120. This allows for an easy means of extending the wiring from the wiring harness 310 to the induction lamp. In other embodiments, a wiring harness 310 may be located in other positions, such as at an opening at the head 120 for easier access. In yet other embodiments, a wiring harness 310 may not be utilized.

Also, it should be noted that a ballast exists somewhere between the electrical source and the lamp. The ballast may be placed in the electrical flow prior to the lamp socket extender, or after the lamp socket extender. For lighting applications where the ballast is small enough, it may be possible to place the ballast somewhere in or at the lamp socket extender.

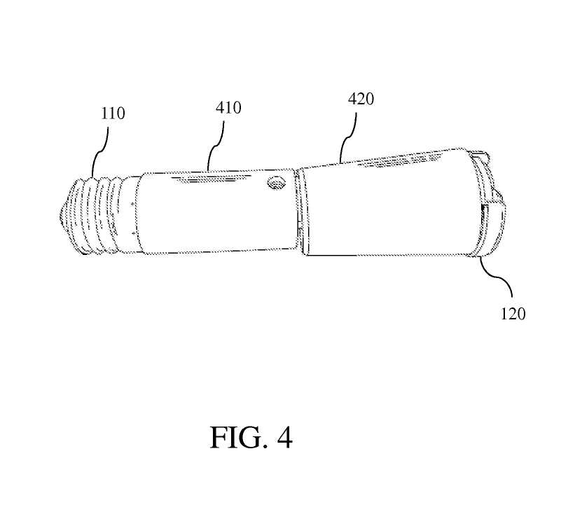

In FIG. 4, a preferred embodiment of the lamp socket extender is shown in its fully extended position. The lamp socket extender in FIG. 4 has its base 110 to the left and head 120 to the right. At the base 110 is the Edison screw. Adjacent to the Edison screw is the extendable body, which is comprised of the core covering 410 and telescopic covering 420. The telescopic covering 420 is shown to the right of the core covering, since the lamp socket extender is in its fully extended position here. In its full retracted position, the telescopic covering 420 overlaps over the core covering 410. The telescopic covering 420 has a diameter that is larger than the diameter of the core covering 410, allowing it to slide over the core covering 410. The telescopic covering 420 in this embodiment serves as a cosmetic cover. To the right of the telescopic covering 420 is the head 120. It is preferred that the telescopic covering 420 is able to snap or snuggly attach with the head 120, and also be detachable from the head 120.

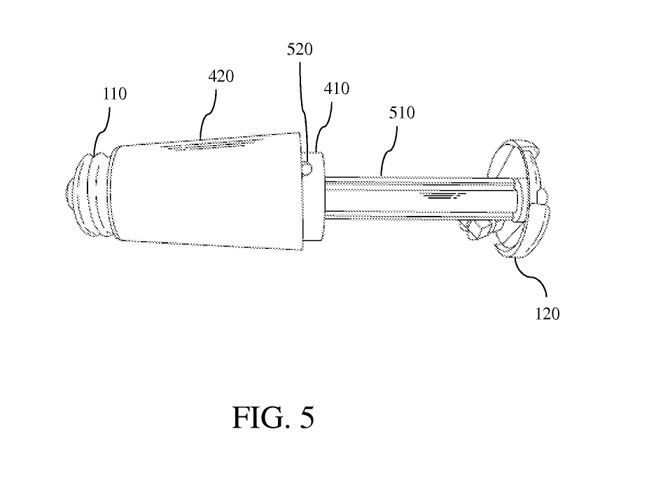

The telescopic covering 420 may slide over the core covering 410, and FIG. 5 shows the telescopic covering detached from the head 120 and slid back over the core covering 410. FIG. 5 exposes what is underneath the telescopic covering 420 when the lamp socket extender is in its fully extended position. Underneath the core covering 410, is a track that holds an extension arm 510 and allows the extension arm 510 to slide in and out of the base covering 410. The extension arm 510 may be held in place relative to the track through the use of an extension arm holding screw 220 which may be tightened enough to prevent movement between the extension arm 510 and base covering 410. The extension arm holding screw 220 goes directly through a screw hole 520 in the base covering 410 and comes into contact with the extension arm 510 to apply holding force when tightened. The extension arm holding screw 220 may be loosened to allow adjustment of the extension arm 510. It is well known to those skilled in the art that there are a variety of means for locking the extension arm 510 in place. In a preferred embodiment, the extension arm 510 is unable to be extended beyond a certain point to prevent the extension arm 510 from sliding off the track. A simple stopper may be used to prevent the extension arm 510 from sliding beyond a certain limit.

The functionality of the extendable body described above is derived from the preferred embodiment. There are a variety of other means for providing the extension functionality. For example, rather than a core covering with a telescopic covering which slides over the core covering, other types of expandable coverings may be utilized, such as an accordion style covering, multiple telescopic coverings, and other types well known to those skilled in the art. Similarly, the functionality of the extension arm sliding over a track is described as the preferred embodiment, but there are many other means for providing this extension functionality as is well known to those skilled in the art.

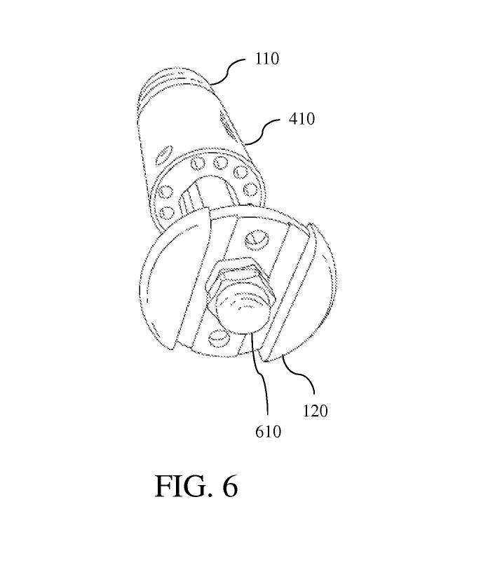

FIG. 6 provides a clear view of the head 120 of the preferred embodiment. The head 120 of this embodiment is designed to be fixedly attached to the lamp adapter which holds the lamp. The hex bolt 610 may be removed and used to bolt the lamp adapter to the head 120 of the lamp socket extender. As is known to those skilled in the art, there are a variety of other means for attaching a lamp adapter to the head 120, such as other styles of screws, clip on, fasteners, and various locking mechanisms. In addition, other types of lamp adapters may be produced to hold a variety of lamp sizes and shapes. Through this design, the actual lamp may be switched out by simply removing the hex bolt 610 and disconnecting the lamp's wire at the wiring harness 310. Through this design, it avoids the previous hassle of retrofitting, which required creating a new bracket for each new lamp.

FIG. 1 shows an embodiment of a lamp adapter 130 which has been designed to attach to a circular induction lamp 140 at the coils 150 160. This lamp adapter 130 bolts on to the head 120 via a hex bolt 610. The lamp adapter 130 is fixedly attached to the induction lamp 140. Through the use of the lamp socket extender 100, the distance of the induction lamp relative to the lamp socket may be adjusted. This may provide a level of flexibility and adjustment, especially when retrofitting a standard lamp socket with an induction lamp.

Although the present invention has been described in detail with respect to certain embodiments and examples, variations and modifications exist which are within the scope of the present invention as defined in the following claims.

What is claimed is:

1. A lamp socket extender comprising:
a base section with a means for attaching to a light socket;
a head section with a means for attaching to a lamp adapter, wherein said lamp adapter is fixedly attached to a lamp; and
an extendable body between said base section and said head section.

2. The lamp socket extender of claim 1 wherein said extendable body is comprised of a core covering and a telescopic covering.

3. The lamp socket extender of claim 2 wherein said extendable body is further comprised of a track underneath said core covering and a telescopic arm sliding on said track to extend the distance of said head section from said base section.

4. The lamp socket extender of claim 3 further comprising an extension arm holding screw.

5. The light socket extender of claim 2 wherein said light socket is an Edison style light socket.

6. The lamp socket extender of claim 5 wherein said lamp is an induction lamp.

7. The lamp socket extender of claim 6 wherein said means for attaching to a lamp adapter is through the use of a screw.

8. A light socket extender comprising:
a base section with a means for attaching to a light socket;
a head section with a means for attaching to a lamp adapter, wherein said lamp adapter is fixedly attached to a lamp;
an extendable body between said base section and said head section;
a first wire carrying electrical current from said base section to a first wiring harness;
a second wire carrying electrical current from said lamp to a second wiring harness, wherein said second wiring harness is attached to said first wiring harness.

9. The lamp socket extender of claim 8 wherein said extendable body is comprised of a core covering and a telescopic covering.

10. The lamp socket extender of claim 9 wherein said extendable body is further comprised of a track underneath said core covering and a telescopic arm sliding on said track to extend the distance of said head section from said base section.

11. The lamp socket extender of claim 10 further comprising an extension arm holding screw.

12. The lamp socket extender of claim 8 wherein said light socket is an Edison style light socket.

13. The lamp socket extender of claim 12 wherein said lamp is an induction lamp.

14. The lamp socket extender of claim 13 wherein said means for attaching to a lamp adapter is through the use of a screw.

15. A lamp socket extender comprising:
a base section with a means for attaching to a light socket;
a head section with a means for attaching to an induction lamp adapter, wherein said induction lamp adapter is fixedly attached to an induction lamp; and
an extendable body between said base section and said head section.

16. The lamp socket extender of claim 15 wherein said induction lamp is a circular induction lamp.

17. The lamp socket extender of claim 16 wherein said circular induction lamp is comprised of two coils, and said induction lamp adapter is fixedly attached to said two coils.

18. The lamp socket extender of claim 17 wherein said light socket is an Edison style light socket.

19. The lamp socket extender of claim 18 wherein said extendable body is comprised of a core covering and a telescopic covering.

20. The lamp socket extender of claim 19 wherein said extendable body is further comprised of a track underneath said core covering and a telescopic arm sliding on said track to extend the distance of said head section from said base section.
